(19) United States
(12) Patent Application Publication
(10) Pub. No.: US 2005/0047505 A1
(43) Pub. Date: Mar. 3, 2005

(54) Adaptive fast DCT method

(75) Inventor: Seung-Cheol Lee, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/918,919

(22) Filed: Aug. 16, 2004

(30) Foreign Application Priority Data
Sep. 1, 2003 (KR) 2003-60821

(51) Int. Cl. H04N 7/12

(52) U.S. Cl. 375/240.2

(57) ABSTRACT

An adaptive two-dimensional fast DCT (Discrete Cosine Transform) encoding method capable of encoding an image in a mobile communication terminal, reducing an amount of operations, and reducing power consumption adaptively using a fast DCT method. In a first step, a smoothness (N) of a block image to be processed is determined. Then fast DCT encoding in a row direction for the block image performed and operation values not exceeding the smoothness (N) are output. Next, fast DCT encoding in a column direction for the block image is performed by using result values obtained from the fast DCT encoding operation in the row direction and only operation values not exceeding the smoothness (N) are output.

### PRIORITY

This application claims priority to an application entitled “Adaptive Fast DCT Method” filed in the Korean Industrial Property Office on Sep. 1, 2003 and assigned Serial No. 2003-60821, the contents of which are hereby incorporated by reference.

### BACKGROUND OF THE INVENTION

1. Field of the Invention

The present invention relates generally to a method for encoding a still image/moving image, and more particularly to a discrete cosine transform (DCT) method.

2. Description of the Related Art

A DCT method, which is widely used as a transform method in image compression, has advantages of good compressibility of spatial energy and a fast processing speed. Different from other types of transform methods, the DCT method includes many well-known fast processing methods, which greatly contribute to the commercialization of JPEG (Joint Photographic Expert Group), MPEG (Motion Picture Experts Group), etc., to which the DCT method is applied.

Standard still image/moving image compression methods of the ISO (International Organization of Standardization)/IEC (International Electrotechnical Commission)/ITU-T (International Telecommunication Union-Telecom) series, not including the H.264 (MPEG4 part 10), which is currently under standardization, employ a DCT method in a two-dimensional 8×8 unit format. Currently, two-dimensional 8×8 unit segments are produced by artificial segmentations and then each relevant unit segment is transformed by DCT.

FIG. 1 is a view for illustrating a calculation result obtained from encoding by a conventional fast DCT method. In FIG. 1, (a) illustrates an entire picture divided into two-dimensional 8×8 unit segments, (b) illustrate an 8×8 unit segment of a smooth picture including a few high-frequency components in the entire picture, and (c) illustrates an 8×8 unit segment of a complex picture including many high-frequency components in the entire picture.

As illustrated in FIG. 1, in the smooth picture (b), the calculated values are located together on an upper left side and occupy a very small domain. The values exist only in a 2×2 domain of the 8×8 segment and the rest domain has no value, that is, has a value of ‘0’. However, in the complex picture (c), the calculated values similarly are located together on an upper left side, but occupy a very large domain. The values exist in a 6×6 domain of the 8×8 segment and the rest domain has no value, that is, has a value of ‘0’.

FIGS. 2A and 2B are illustrative views for explaining a high frequency calculation in which a conventional fast DCT method is applied to an 8×8 domain. More specifically, FIG. 2A illustrates the conventional fast DCT method applied to an 8×8 domain in a row direction, and FIG. 2B illustrates the conventional fast DCT method applied to an 8×8 domain in a column direction.

In the conventional fast DCT method, regardless whether it is applied in the row direction or in the column direction, 8 input values are used, respectively, and 8 output values are calculated through a 4 step-operation using the respective input values and constants. The operation illustrated in FIGS. 2A and 2B is a conventional method called “Chen's fast DCT”, which is well-known by those skilled in the art. More specifically, FIG. 2A illustrates the conventional fast DCT method in a row direction, and FIG. 2B illustrates the conventional fast DCT method in a column direction.

Referring to FIGS. 2A and 2B, Chen's algorithm can be described using the conventional fast DCT method. That is, Chen's algorithm is designed to reduce the operation amount by coupling the first and eighth members, the second and seventh members, the third and sixth members, the forth, and fifth members in order to have a uniform pattern and calculate numerals with a common algorithm. More specifically, DCT encoding in a row direction for a second dimensional image is performed once and DCT encoding in a column direction for the second dimensional image is performed by using result values obtained from the DCT encoding operation in the row operation.

FIG. 3 is a flow chart illustrating a conventional fast DCT method applied to an 8×8 domain. Referring to FIG. 3, in step 301, initialization including storing of input values (Input_data[64]) of all pixels in the 8×8 domain, assigning of a temporary storage region (Temp_data[64]), assigning of an output region (Output_data[64]) to be output after transformation, etc. is performed. The values in the unit of 8 pixels are sequentially input from the “Input_data[64]” in the row direction in step 302, an operation is performed and its result is stored (Temp_data[64]) in step 303, which is repeated eight times in steps 304 and 305.

The values in the unit of 8 pixels are sequentially input from the “Temp_data[64]” in the column direction in step 306, an operation is performed, and its result is stored in the output region (Output_data[64]) in step 307. This procedure is repeated eight times in steps 308 and 309.

However, even though the conventional two-dimensional fast DCT method is employed, which up until now is known as the fastest DCT method, it is not reasonable to apply the conventional DCT method to a mobile communication terminal. That is, in order to design a commercial-level moving image encoder in a mobile communication terminal, a hardware block to provide an SOC (system on chip) or, if using software only, to allocate considerable million instructions per second (MIPS) must be designed. Particularly, there are many circumstances in which values have a value of ‘0’ from the midway of a calculation process and values corresponding to almost three-fourths of an entire block ultimately become ‘0’, but such circumstances are not considered with the result that the calculation process must be performed to the end.

Therefore, using the conventional fast DCT method limits the reduction of chip size in a mobile communication terminal, and creates problems in that operations/calculations are too large for a mobile communication terminal to handle. As a result, power consumption is increased due to a raise a clock frequency, and side effects including serious heat generation occur.

### SUMMARY OF THE INVENTION

Accordingly, the present invention has been designed to solve the above-described problems occurring in the prior art, and an object of the present invention is to provide an adaptive fast DCT method for reducing operation amount and power consumption, and enabling a mobile communication terminal to encode an image.

In order to accomplish the above and other objects, there is provided an adaptive two-dimensional fast DCT (Discrete Cosine Transform) encoding method comprising: determining a smoothness (N) of a block image to be processed; fast DCT encoding in a row direction for the block image and outputting only operation values not exceeding the smoothness (N); and fast DCT encoding in a column direction for the block image by using result values obtained from the fast DCT encoding operation in the row direction and outputting only operation values not exceeding the smoothness (N).

### BRIEF DESCRIPTION OF THE DRAWINGS

The above and other objects, features, and advantages of the present invention will be more apparent from the following detailed description taken in conjunction with the accompanying drawings, in which:

FIG. 1 is a view for illustrating a calculation result obtained from an encoding by a conventional fast DCT;

FIGS. 2A and 2B are illustrative views for explaining a high frequency calculation in which the conventional fast DCT method is applied to an 8×8 domain;

FIG. 3 is a flow chart illustrating a conventional fast DCT method applied to an 8×8 domain;

FIGS. 4A and 4B are illustrative views for explaining a high frequency calculation in which a fast DCT method according to the present invention is applied;

FIG. 5 is an operational flow chart of an embodiment of an adaptive fast DCT method according to the present invention;

FIG. 6 is a view illustrating a first example of an image to which the adaptive fast DCT method according to the present invention is applied;

FIG. 7 is a view illustrating a second example of an image to which the adaptive fast DCT method according to the present invention is applied;

FIG. 8 is a view illustrating a third example of an image to which an adaptive fast DCT method according to the present invention is applied;

FIG. 9 is a view illustrating a fourth example of an image in which an adaptive fast DCT method according to the present invention is applied; and

FIGS. 10A and 10B are illustrative views for explaining another high frequency calculation in which the fast DCT method according to the present invention is applied.

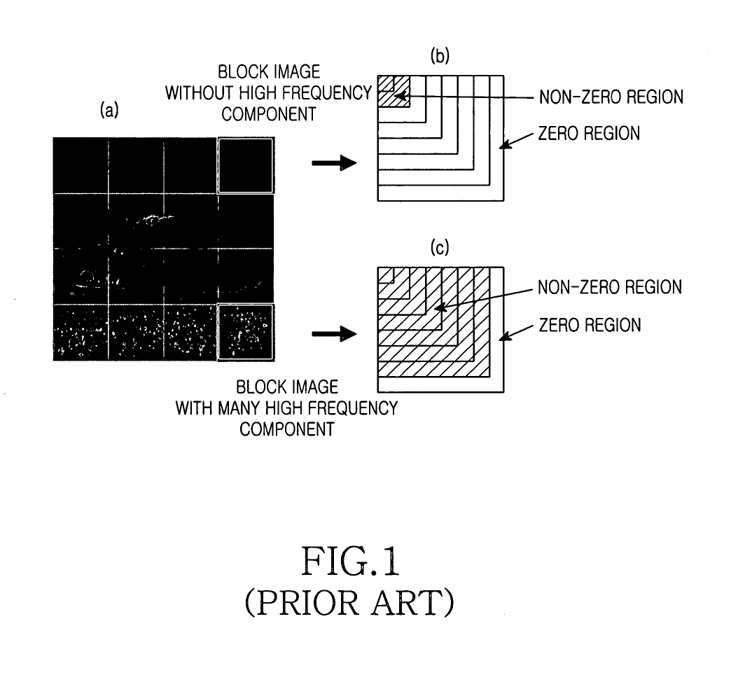

### DETAILED DESCRIPTION OF THE PREFERRED EMBODIMENT

Hereinafter, preferred embodiments of an adaptive fast DCT method according to the present invention will be described in detail with reference to the accompanying drawings. In the following description of the present invention, a detailed description of known functions and configurations incorporated herein will be omitted when it may make the subject matter of the present invention rather unclear. More particularly, a detailed description of operation processes relating to a “Chen's fast DCT” method will be omitted, except for the several parts connected with contents of the present invention.

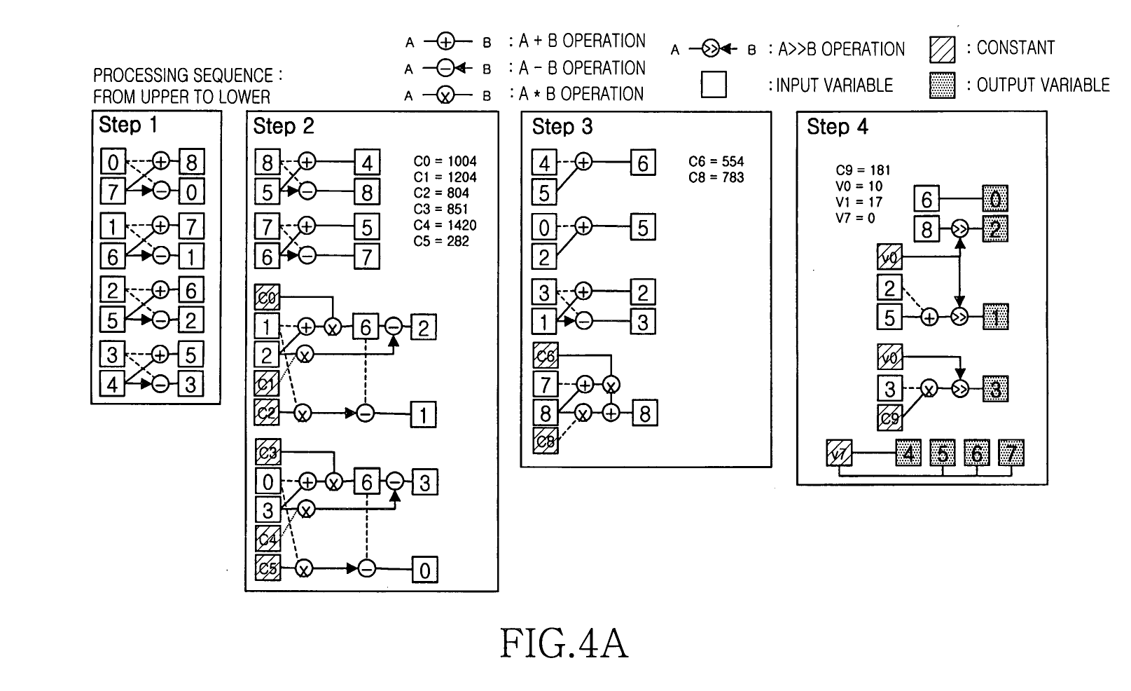

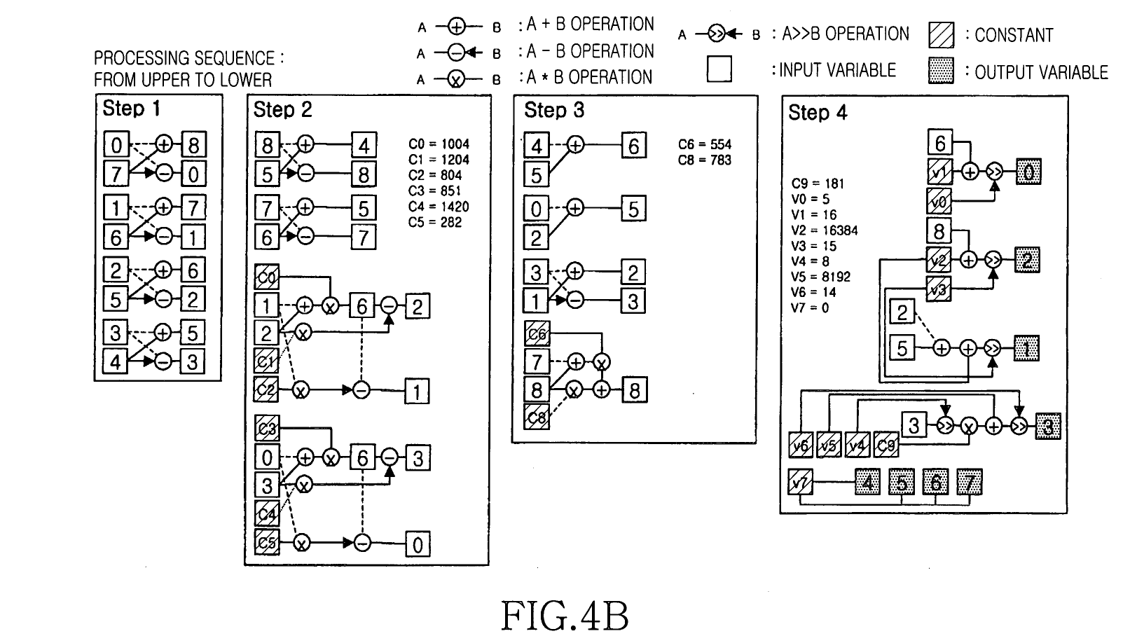

FIGS. 4A and 4B are illustrative views for explaining a high frequency calculation in which a fast DCT method according to the present invention is applied. More specifically, FIG. 4A is an illustrative view in which the fast DCT method according to the present invention is applied to an 8×8 domain in a row direction, and FIG. 4B is an illustrative view in which the fast DCT method according to the present invention is applied to an 8×8 domain in a column direction.

As described above, the conventional fast DCT method uses 8 input values and calculates 8 output values through a 4 step-operation using the respective input values and constants, regardless whether it is applied in the row direction or in the column direction. However, as will be described herein below, in an embodiment of the fast DCT method according to the present invention, it is possible to reduce the operation amount and thus hardware construction because an 8×8 input produces a 4×4 output.

More specifically, from among eight pixels in DCT domain of ‘0’ to ‘7’ at step 4, only four pixels, corresponding to DCT coefficient for low frequency images, ‘0’, ‘1’, ‘2’, and ‘3 have specific values. The remaining four pixels, corresponding to DCT coefficient for high frequency images, ‘4’, ‘5’, ‘6’, and ‘7 have a value of nearly ‘0’. These values converge into zero in the following quantization process. Therefore, it is possible to omit the operations of steps 3 and 4 for obtaining output values of four pixels of ‘4’, ‘5’, ‘6’, and ‘7.

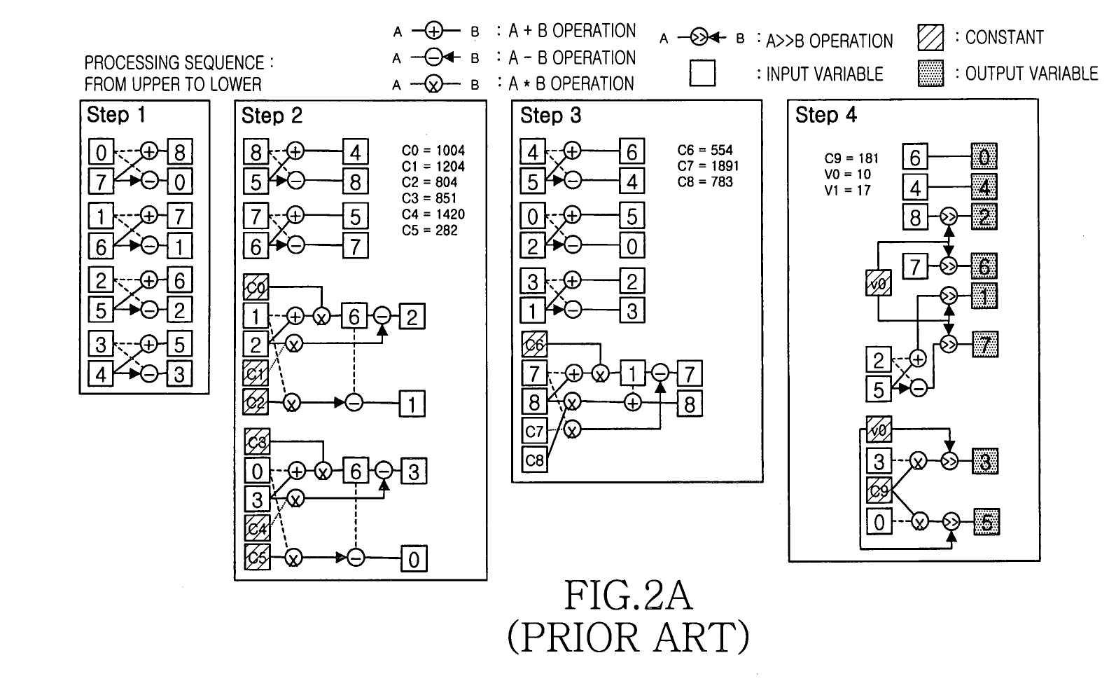

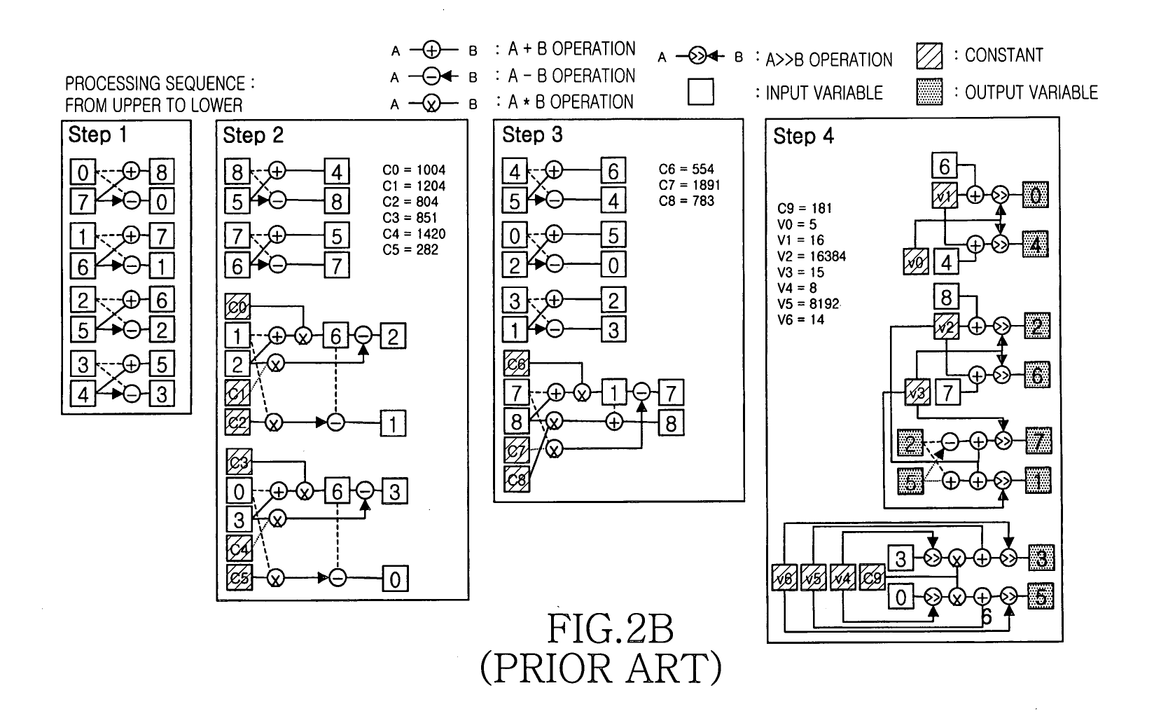

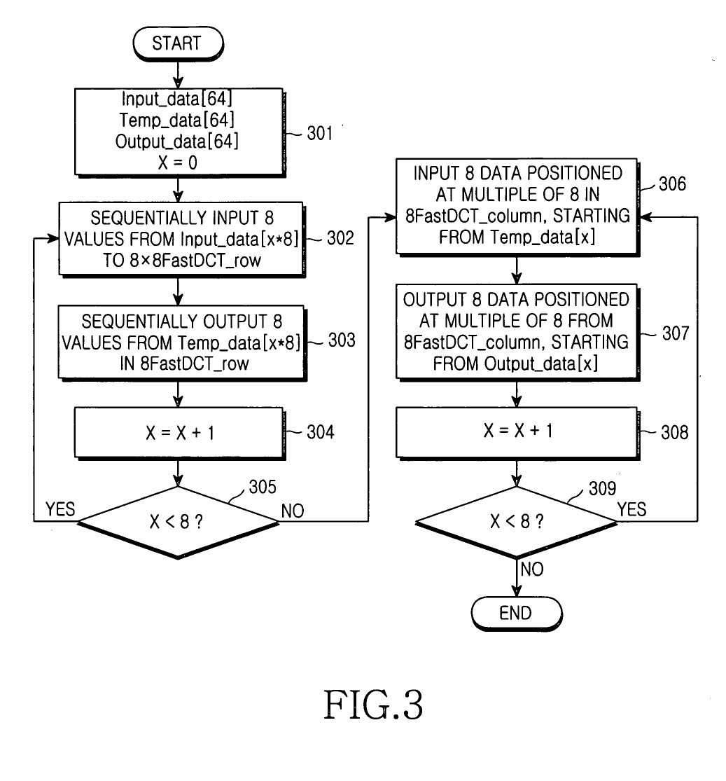

As described above, the fast DCT method according to the present invention as illustrated in FIGS. 4A and 4B is a method that can omit the operations for certain values while intactly using the conventional fast DCT method. In other words, as compared with the conventional method illustrated in FIGS. 2A and 2B, there is a difference at steps 3 and 4, in which the values of pixels corresponding to high frequency images, i.e., pixels of ‘4’, ‘5’, ‘6’, and ‘7 are output as a value of ‘0’ because this embodiment of the present invention exemplifies ‘4×4’ output. Therefore, it is possible to omit all operation equations for calculating the values of pixel ‘4’, ‘5’, ‘6’, and ‘7 at step 4 of FIGS. 2A and 2B. Additionally, because the operation of step 3 is directly connected with that of step 4, it is possible to omit a portion of the operation of step 3, which calculates input values for producing results of pixel ‘4’, ‘5’, ‘6’, and ‘7 at step 4.

More specifically , an example for an output value ‘4’ of step 4 in FIG. 2B will be given herein below.

Referring to FIG. 2B, according to a fast DCT method, the output value ‘4’ of step 4 is determined by adding an output value ‘4’ of step 3 as an input value of step 4 to a constant ‘v1’ and comparing its sum with a constant ‘v0’. Also, the output value ‘4’ of step 3 is determined by subtracting an output value ‘5’ of step 2 from an output value ‘4’ of step 2.

Alternatively, an output value ‘4’ of step 4 in FIG. 4B is determined as a value of ‘0’. Therefore, it is unnecessary to perform the operations illustrated in FIG. 2B. Additionally, at step 3 for producing input values of step 4, it is unnecessary to perform an operation for the output value ‘4’ of step 3, which would be an input value of step 4 for producing the output value ‘4’ of step 4. Accordingly, the respective relevant operations can be omitted.

Accordingly, an image without deterioration of image quality can be produced using operations for ‘4×4’ with respect to an 8×8 input. This is because, in a specific image, i.e., a smooth picture without a high frequency component, most results of the DCT show a value of ‘0’. More particularly, values of ‘0’ are distributed more and more as operations progress from a upper left side toward a lower right side of the image in view of a DCT's property of concentrating operations of high frequency components on the upper left side. However, in order to reduce an operation amount as described above, it is necessary to know a smoothness of an image in advance. Korean Patent Application No. 2002-67850 discloses a method of determining a smoothness of an image by calculating energy of an input image in a spatial domain.

Further, to re-store data in a JPEG/MPEG format after decoding and processing (compiling) or to re-encode (e.g., transcoding) for ensuring compatibility between mobile communication service providers, a smoothness of an image can be exactly determined because the data has already undergone IDCT (Inverse Discrete Cosine Transform).

Additionally, when the quality of an original image itself is bad, as is common with digital video devices, such as a CMOS camera for a wireless terminal, etc., a smoothness of an image can be uniformly assigned.

Once the smoothness of an image is determined, the values fast DCT method output can be determined. When the 4×4 fast DCT method illustrated in FIGS. 4A and 4B is used instead of the conventional 8×8 fast DCT method illustrated in FIGS. 2A and 2B, an example of gain in calculation amount is given as follows:

Assuming that data operations of ‘Idr’, ‘add’, ‘sub’, ‘shift’, ‘mul’, ‘str’, etc. have the same calculation amount, the conventional fast DCT method requires 162 calculations for a row direction processing and these calculations are repeated 8 times. As a result, 1296 calculations (162×8=1296) are required. In the same manner, the conventional fast DCT method requires 186 calculations for a column direction processing, and the calculations are repeated 8 times. As a result, 1488 calculations (186×8=1488) are required. Accordingly, the total calculation amount required for processing one 8×8 block is 2784 (1296+1488=2784).

However, assuming that data operations of ‘Idr’, ‘add’, ‘sub’, ‘shift’, ‘mul’, ‘str’, etc. have the same number of calculations, the 4×4 fast DCT method of the present invention requires 138 calculations for a row direction processing and the calculations are repeated 8 times. As a result, only 1104 calculations (138×8=1104) are required. Similarly, the 4×4 fast DCT method requires 150 calculations for a column direction processing, and these calculations are repeated 4 times and operations of storing a value of ‘0’ are repeated 4 times. As a result, only 664 calculations (150×4+16×4=664) are required. Accordingly, the total calculation amount required for processing one 8×8 block is 1768 (1104+664=1768).

Therefore, the operation amount, i.e., the number of calculations required, in the embodiment according to the present invention is 63.5% of the prior art (1768/2784×100=63.5%). That is, in the present invention, DCT can be operated with an operation amount of no more than 63.5% of that of the prior art.

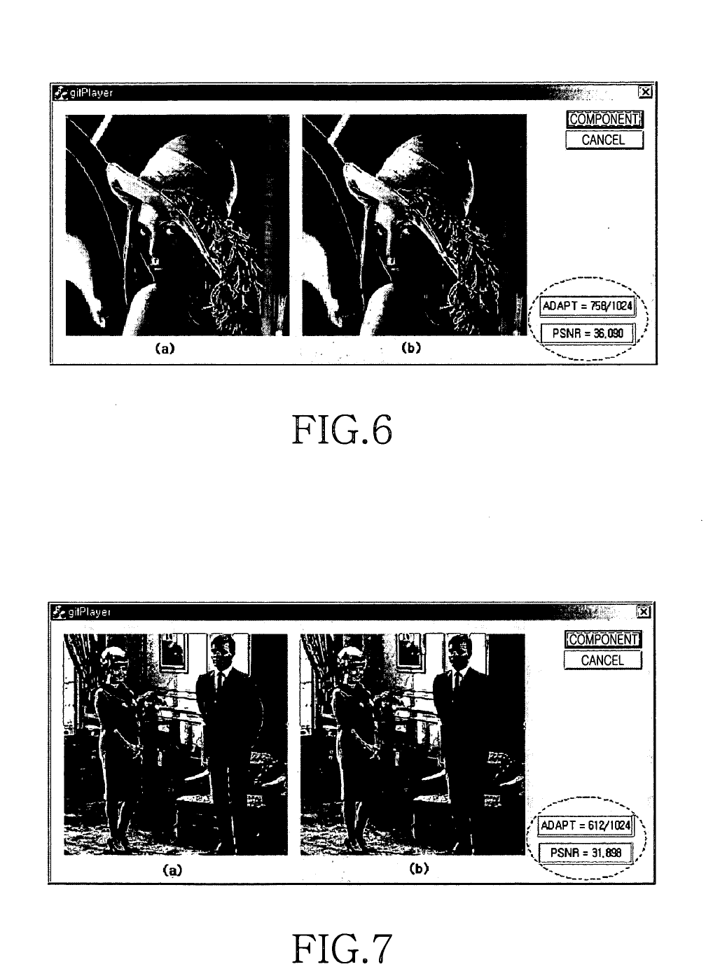

The above comparison is only an example, and such a difference in operation amount depends on properties of an image and given conditions. The differences will be described later by way of examples in FIGS. 6 to 9.

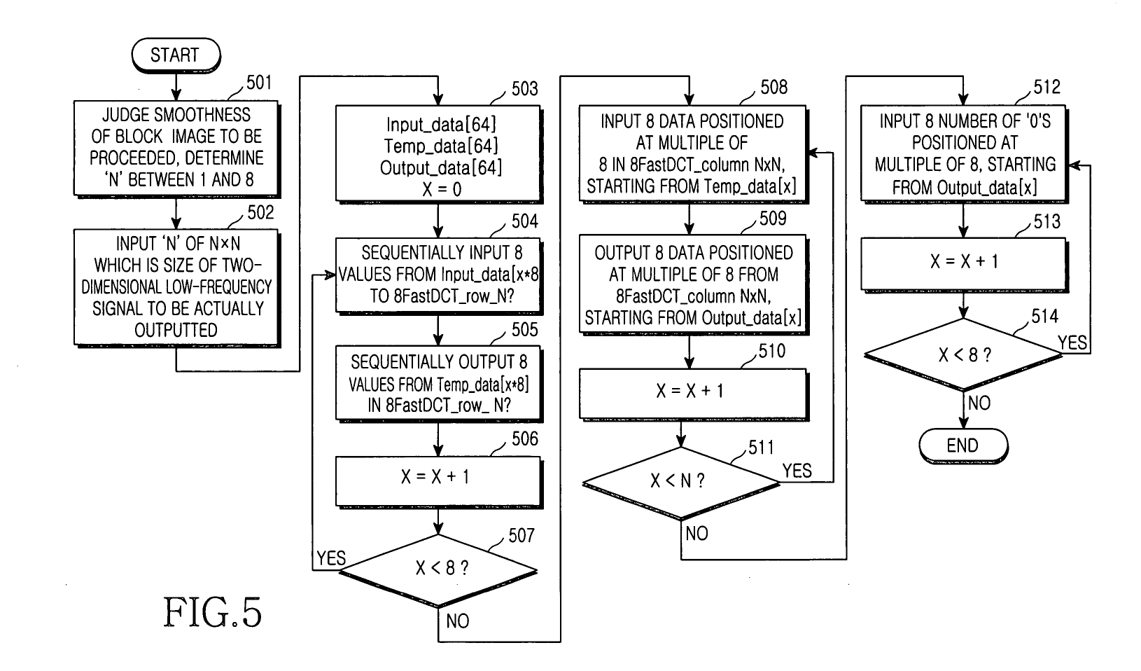

FIG. 5 is a flow chart of an adaptive fast DCT method according to the present invention. Referring to FIG. 5, in step 501, a smoothness for a block image (8×8) to be processed is determined in order to determine a value of ‘N’. A value of ‘N’ represents a domain in which an operation value of a high frequency component, not a value of ‘0’, exists in the block image. An operation value according to the determined value of ‘N’ has a ‘N×N’ value, which is a size of an actually output two-dimensional low-frequency signal.

In step 502, the determined value of ‘N’ is input, and then an initialization process, which includes storing of input values (Input_data[64]) of all pixels in the 8×8 domain, assigning of a temporary storage region (Temp_data[64]), assigning of an output region (Output_data[64]) for output after transform, etc., is performed in step 503. The values in the unit of 8 pixels are sequentially input from the “Input_data[64]” in the row direction in step 504, an operation is performed, and its result is stored (Temp_data[64]) in step 505. The function of 8×8 Fast DCT_row_N×N performs the process described in FIG. 4A. As described above, a portion of the operation of step 3 and step 4, which calculates input values for producing results of pixel ‘4’, ‘5’, ‘6’, and ‘7 at step 4 is omitted. This process is repeated eight times in steps 506 and 507.

Next, values in the unit of 8 pixels are sequentially input from the “Temp_data[64]” in the column direction in step 508, an operation is performed, and its result is stored in the output region (Output_data[64]) in step 509). This procedure is repeated ‘N’ times in steps 510 and 511.

Then, a value of ‘0’ is input for a domain above the determined value of ‘N’ in step 512. This procedure is repeated 8−N times in steps 513 and 514.

FIG. 6 is a view illustrating a first example of an image to which the adaptive fast DCT method according to the present invention is applied. In FIG. 6, ‘(a)’ designates an original image and ‘(b)’ designates an image to which an adaptive fast DCT method according to the present invention is applied. The image illustrated in ‘(b)’ of FIG. 6 is comparatively smooth. In this example, a condition for determining that the image has no high frequency component is that the number of coefficients not having a value of ‘0’ is 3 or less when high frequency coefficients having a value of ‘−3’ to ‘+3’ are processed as a value of ‘0’. Therefore, when it is determined that there is no high frequency component in any other domain except for a low frequency domain of ‘4×4’, the adaptive fast DCT method (4×4 output) is applied.

In this example, an application rate of the adaptive fast DCT is (758/1024)×100=74.0%. Therefore, the calculation gain is (63.5×0.74)+(100×(1−0.74))=73.0%. Also, a peak-signal-to-noise ratio (PSNR) is 36.1 dB, which shows that there is a little deterioration of the image quality.

FIG. 7 is a view illustrating a second example of an image to which the adaptive fast DCT method according to the present invention is applied. In FIG. 7, ‘(a)’ designates an original image and ‘(b)’ designates an image in which an adaptive fast DCT method according to the present invention is applied. The image shown in ‘(b)’ of FIG. 7 is not as smooth as the image shown in ‘(a)’. In this example, the condition for determining that the image has no high frequency component is that the number of coefficients not having a value of ‘0’ is 3 or less when high frequency coefficients having a value of ‘−3’ to ‘+3’ are processed as a value of ‘0’. Therefore, when it is determined that there is no high frequency component in any other domain except for a low frequency domain of ‘4×4’, the adaptive fast DCT method (4×4 output) is applied.

In this example, an application rate of the adaptive fast DCT is (612/1024)×100=59.7%, and thus calculation gain is (63.5×0.597)+(100×(1−0.597))=78.2%. Also, a peak-signal-to-noise ratio (PSNR) is 31.9 dB, which shows that there is some deterioration of the image quality. However, in a complex image like FIG. 7, although image quality is somewhat deteriorated, human eyes cannot easily sense this deterioration, and it is not a big problem that some deterioration of the image quality occurs in a complex image.

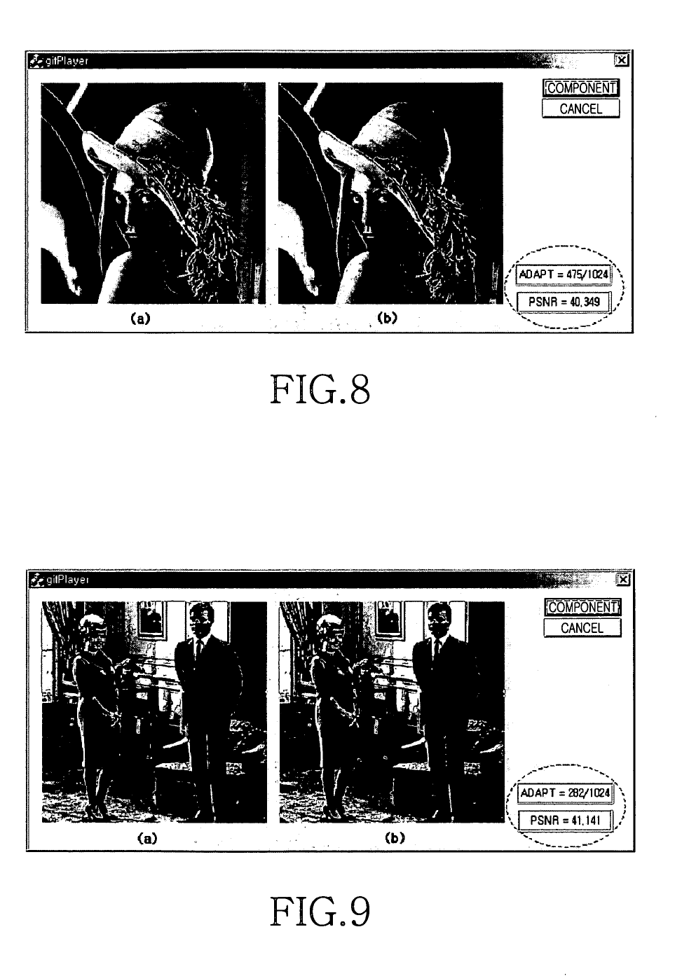

FIG. 8 is a view illustrating a third example of an image to which the adaptive fast DCT method according to the present invention is applied. In FIG. 8, ‘(a)’ designates an original image and ‘(b)’ designates an image in which an adaptive fast DCT method according to the present invention is applied. The image shown in ‘(b)’ of FIG. 8 is comparatively smooth. In this example, the condition for determining whether the image has no high frequency component is that the number of coefficients not having a value of ‘0’ is 3 or less when high frequency coefficients having a value of ‘−1’ to ‘+1’ are processed as a value of ‘0’. Therefore, when it is determined that there is no high frequency component in any other domain except for a low frequency domain of ‘4×4’, the adaptive fast DCT method (4×4 output) is applied.

In this example, an application rate of the adaptive fast DCT is (475/1024)×100=46.4%. Therefore, the calculation gain is (63.5×0.464)+(100×(1−0.464))=83.1%. Also, a peak-signal-to-noise ratio (PSNR) is 40.3 dB, which shows that there is little deterioration of image quality.

FIG. 9 is a view illustrating a fourth example of an image to which the adaptive fast DCT method according to the present invention is applied. In FIG. 9, ‘(a)’ designates an original image and ‘(b)’ designates an image in which an adaptive fast DCT method according to the present invention is applied. The image shown in ‘(b)’ of FIG. 9 is not as smooth when compared with ‘(a)’. In this example, the condition for determining whether the image has no high frequency component is that the number of coefficients not having a value of ‘0’ is 3 or less when high frequency coefficients having a value of ‘−1’ to ‘+1’ are processed as a value of ‘0’. Therefore, when it is determined that there is no high frequency component in any other domain except for a low frequency domain of ‘4×4’, the adaptive fast DCT method (4×4 output) is applied.

In this example, an application rate of the adaptive fast DCT is (282/1024)×100=27.5%. Therefore, the calculation gain is (63.5×0.275)+(100×(1−0.275))=90.0%. Additionally, a peak-signal-to-noise ratio (PSNR) is 41.1 dB, which shows that there is little deterioration of image quality.

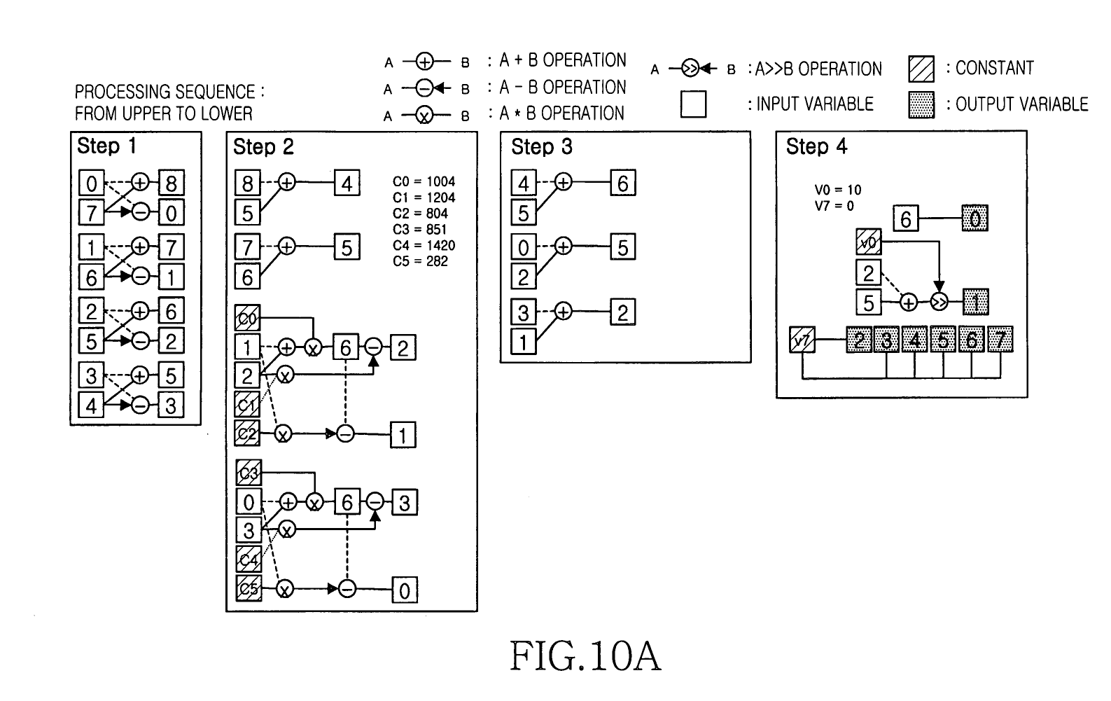

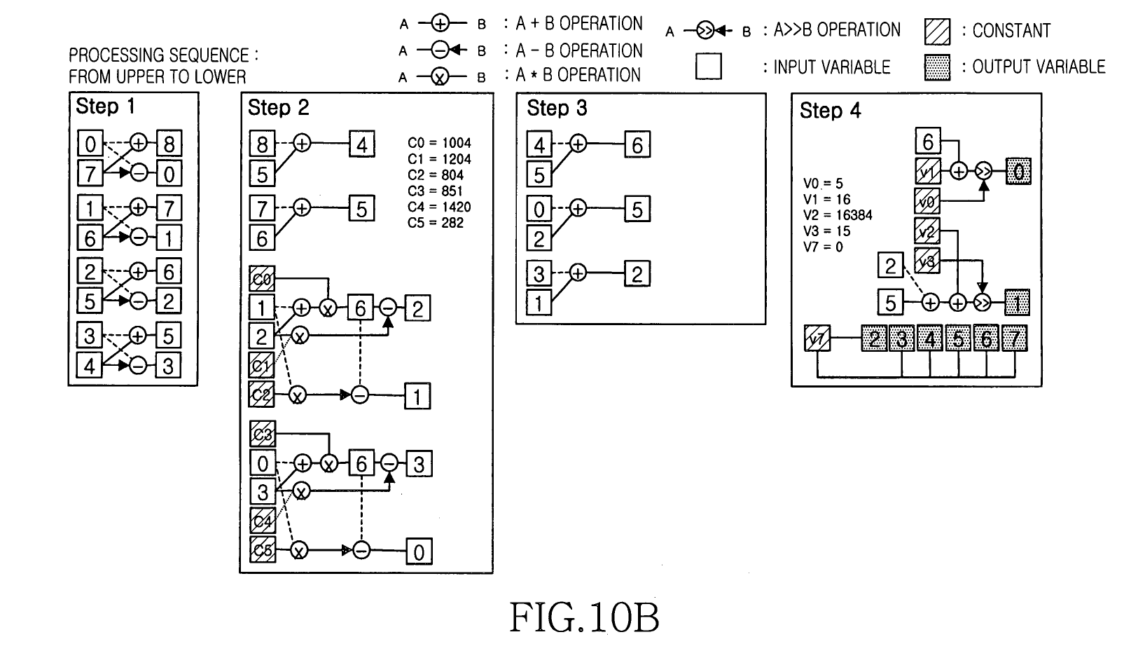

FIGS. 10A and 10B are illustrative views for explaining another high frequency calculation in which the fast DCT method according to the present invention is applied. More specifically, FIG. 10A is an illustrative view in which a fast DCT method according to the present invention is applied to an 8×8 domain in a row direction, and FIG. 10B is an illustrative view in which a fast DCT method according to the present invention is applied to an 8×8 domain in a column direction.

As described above, the conventional fast DCT method uses 8 input values and calculates 8 output values through a 4 step-operation using the respective input values and constants regardless whether it is applied in the row direction or in the column direction. However, in the present invention, it is possible to reduce an operation amount and thus the hardware construction because an 8×8 input produces a 2×2 output in this embodiment of the fast DCT method according to the present invention.

More specifically, from among eight pixels of ‘0’ to ‘7’ in DCT domain to be output at step 4, only two pixels of ‘0’ and ‘1’, which corresponds to low frequency images having specific values, and the other six pixels of ‘2’, ‘3’, ‘4’, ‘5’, ‘6’, and ‘7, which corresponds to high frequency images having a value of nearly ‘0’. Therefore, it is possible to omit the operations of steps 3 and 4 for obtaining output values of six pixels of ‘2’, ‘3’, ‘4’, ‘5’, ‘6’, and ‘7.

As described above, the fast DCT method according to the present invention illustrated in FIGS. 10A and 10B is a method, which can omit the operations for certain values while intactly using the conventional fast DCT method.

The present invention as described above provides a fast DCT method, which is faster than the existing fast DCT method currently known as the fastest method.

Also, according to the reduction amount of calculations, when the fast DCT method of the present invention is employed in a small-size apparatus such as a mobile communication terminal, it is possible to design a highly efficient still-image/moving-image encoder with image quality maintained and to reduce power consumption in the mobile communication terminal.

Additionally, the method according to the present invention can be realized by a program and can be stored in a recording medium (such as a CD ROM, a RAM, a floppy disk, a hard disk, an optical and magnetic disk, etc.) in a format that can be read by a computer.

While the present invention has been shown and described with reference to certain preferred embodiments thereof, it will be understood by those skilled in the art that various changes in form and details may be made therein without departing from the spirit and scope of the present invention as defined by the appended claims.

1. An adaptive two-dimensional fast DCT (Discrete Cosine Transform) encoding method comprising:
determining a smoothness (N) of a block image to be processed;
fast DCT encoding the block image in a row direction and outputting operation values for up to N pixels in each row;
fast DCT encoding the block image in a column direction by using result values obtained from the fast DCT encoding operation in the row direction; and
outputting only operation values for up to N pixels in each column.

2. The adaptive two-dimensional fast DCT encoding method as claimed in claim 1, wherein the smoothness (N) is determined according to a block size (M) of the block image to be processed.

3. The adaptive two-dimensional fast DCT encoding method as claimed in claim 2, wherein, after the smoothness (N) is determined, all rows (N+1th row to Mth row) exceeding the smoothness (N) are set to a value of ‘0’ in the two-dimensional fast DCT encoding method.

4. The adaptive two-dimensional fast DCT encoding method as claimed in claim 2, wherein, after the smoothness (N) is determined, all columns (N+1 row to Mth row) exceeding the smoothness (N) are set to a value of ‘0’ in the two-dimensional fast DCT encoding method.

5. The adaptive two-dimensional fast DCT encoding method as claimed in claim 1, wherein the smoothness is judged by energy calculation for an input image.

6. The adaptive two-dimensional fast DCT encoding method as claimed in claim 1, wherein, when re-encoding, the smoothness (N) is determined IDCT (Inverse Discrete Cosine Transform) prior to the re-encoding.

7. The adaptive two-dimensional fast DCT encoding method as claimed in claim 1, wherein, when a quality of an original image is below a predetermined threshold, the smoothness (N) is determined by uniformly assigning a smoothness value and using the assigned values.

8. An adaptive two-dimensional fast DCT (Discrete Cosine Transform) encoding method comprising:
determining a smoothness (N) of a block image to be processed;
calculating DCT coefficients up to N pixels in each row of the block image;
setting the DCT coefficients for pixels exceeding N in each row as zero;
outputting temporary pixel values;
calculating DCT coefficients up to N pixels in each column up to Nth column by using the temporary pixel values; and
setting DCT coefficients for pixels exceeding N in each column as zero.

9. The adaptive two-dimensional fast DCT encoding method as claimed in claim 8, wherein the smoothness (N) is determined according to a block size (M) of the block image to be processed.
